(19) United States
(12) Patent Application Publication
(10) Pub. No.: US 2014/0319159 A1
(43) Pub. Date: Oct. 30, 2014

(54) STACKABLE LIDS WITH REMOVABLE HANDLES

(71) Applicant: Wieslaw J. Bochenek, Newtown, PA (US)

(72) Inventor: Wieslaw J. Bochenek, Newtown, PA (US)

(21) Appl. No.: 13/869,393

(22) Filed: Apr. 24, 2013

(51) Int. Cl. A47J 36/06

(52) U.S. Cl. CPC A47J 36/06
USPC 220/759

(57) ABSTRACT

Lids, e.g., for cookware such as pots and pans are disclosed. The lids have removable handles and are stackable when the handles are removed. The handles are removable from and attachable to the lids without the use of tools.

### BACKGROUND OF THE INVENTION

1. Field of Invention

This invention relates to stackable lids with removable handles, such as for cookware and the like.

2. Description of Related Art

Lids for cookware, such as for pots and pans, typically have a handle, which allows a user to remove and replace the lid as needed, e.g., during cooking. Without such a handle, a user would not have the means to safely and conveniently remove and replace the lid on a pot and pan containing extremely hot contents.

Typically, people stock many pots, pans and other cookware in their kitchens. The lids for such cookware may come in different shapes and sizes. Typically, handles protrude from the tops of the lids. These handles are manufactured to be permanently affixed to the lids and are thus not removable from the lids without the use of tools, if at all. For example, some handles are internally threaded and are affixed to the lid with a machine screw. Removal of such a handle would require rotating the screw several times with a screwdriver, until the screw is removed, thereby detaching the handle from the lid. Some handles are affixed to the lids in such a way that removal of the handle or even attempts to remove the handle could damage the lid.

Typically, cookware lids are stored in cabinets rather haphazardly. The lids may be strewn about a cabinet in no particular order, making it difficult for a user to locate a specific lid. If a user is a bit more organized, (s)he may pile the lids on top of one another. However, by placing lids on top of one another, the handle protruding from the top of one lid contacts and interferes with the underside of the other lid directly above it. Thus, an assembly comprising a plurality of such lids piled one on top of the other is unstable and tends to fall apart rather easily. In addition, since the handle of one lid props up the underside of the lid directly above it, there a gap created between these lids—a gap which hinders maximization of usable storage space.

Accordingly, what is needed are lids, e.g., for cookware, that have removable handles and which are conveniently stackable when the handles are removed. Further, the handles should be removable from and attachable to the lids without the use of tools and with minimal effort.

### BRIEF SUMMARY OF THE INVENTION

First and second cookware lids are provided. The first cookware lid has a first handle removable therefrom and removably securable thereto without using a tool. The second cookware lid has a second handle removable therefrom and removably securable thereto without using a tool . The first cookware lid is stackable onto the second cookware lid when the second handle is not secured to the second cookware lid.

### BRIEF DESCRIPTION OF SEVERAL VIEWS OF THE DRAWINGS

The invention will be described in conjunction with the following drawings in which like reference numerals designate like elements and wherein:

FIG. 1A is an isometric view of a first exemplary embodiment of a lid and handle combination of the present invention.

FIG. 1B is an isometric view of the lid and handle shown in FIG. 1A, wherein the handle is separated from the lid.

FIG. 2A is an isometric view of a second exemplary embodiment of a lid and handle combination of the present invention.

FIG. 2B is an isometric view of the lid and handle shown in FIG. 2A, wherein the handle is separated from the lid.

FIG. 3 is an isometric view of a third exemplary embodiment of a lid and handle combination of the present invention, wherein the handle is separated from the lid.

FIG. 4 is an isometric view of a fourth exemplary embodiment of a lid and handle combination of the present invention, wherein the handle is separated from the lid.

FIG. 5 is a sectional view of a plurality of stacked lids wherein the handles are not attached to the lids.

FIG. 6 shows top views of two different sized lids according to the fourth exemplary embodiment of the lid and handle combination shown in FIG. 3.

### DETAILED DESCRIPTION OF THE INVENTION

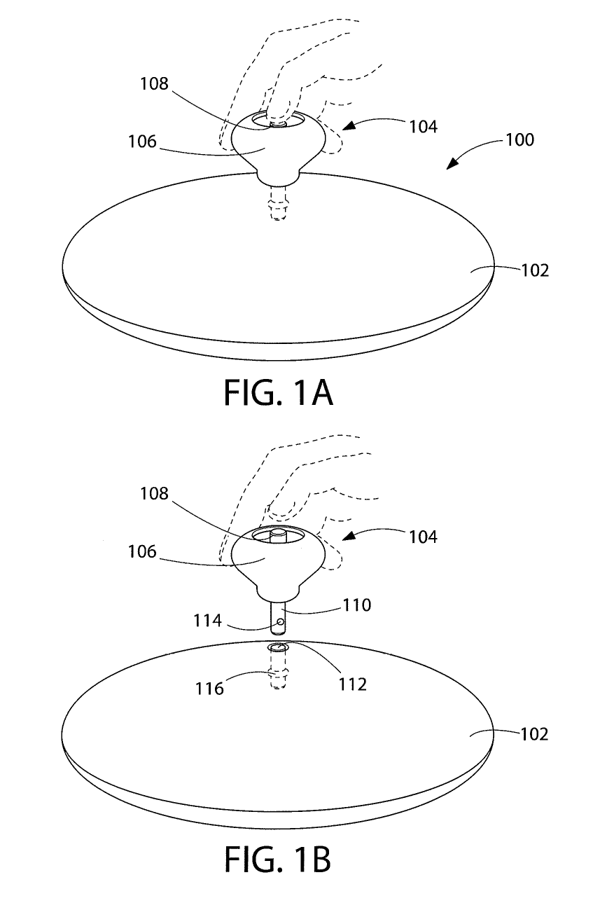

Referring now in detail to the various figures of the drawings wherein like reference numerals refer to like parts, there are shown in FIGS. 1A and 1B isometric views of a first exemplary embodiment of a lid and handle combination 100 of the present invention. The combination 100 includes a lid 102 and handle 104 removably secured thereto, as shown in FIG. 1A.

The handle 104 includes a knob 106 and a shaft 110, the shaft 110 being insertable into an axial cavity 112, preferably centrally located on the top of the lid 102. A portion of the shaft 110 is preferably hollow and includes therein a spring-biased nub 114, which in its natural state is biased in a direction away from the central axis of the shaft 110. The nub 114 may be retracted (i.e., towards the central axis of the shaft 110) by manually pushing in the nub or by depressing a push-button 108 that is preferably located on top of the handle 104.

The axial cavity 112 in the lid 102 further includes a hollow 116 around the periphery of the interior of the axial cavity 112. When the handle 104 is secured to the lid 102, the shaft 110 is inserted into the axial cavity 112 and the nub 114 is biased away from the central axis of the shaft 110. The nub 114 thus protrudes into the hollow 116, thereby securing the handle 104 to the lid 102. Preferably, the shaft includes an additional spring biased nub (not shown), e.g., located opposite the nub 114 shown, in order to strengthen the connection between the handle 104 and the lid 102. If such an additional spring biased nub is included, depression of the push-button 108 would retract the additional nub as well as the nub 114 shown in the figures.

When a user desires to separate the lid and handle combination 100, the user may depress the push-button 108 as shown in FIG. 1A and simply pull the handle 104 away from the lid 102. To reattach the handle 104 to the lid 102, the user may depress the push-button 108, thereby retracting the nub 114, insert the shaft 110 into the axial cavity 112 and release the push-button 108. The nub 114 will then be biased away from the central axis of the shaft 110 and protrude into the hollow 116, thereby securing the shaft 110 within the axial cavity 112. Using this type of snap-fit, the handle 104 may be removably secured to and detached from the lid 102, with minimal effort and without the use of tools. Alternatively, a snap-fit or slight interference fit between the shaft 110 and the axial cavity 112 without a push-button mechanism may be implemented such that a user may separate the handle from the lid by applying sufficient manual pulling force to the handle. However, the lid and handle should not be separable by pulling on the handle with slight or inadvertent force, e.g., such force as would be exerted in normal use through simply lifting the lid.

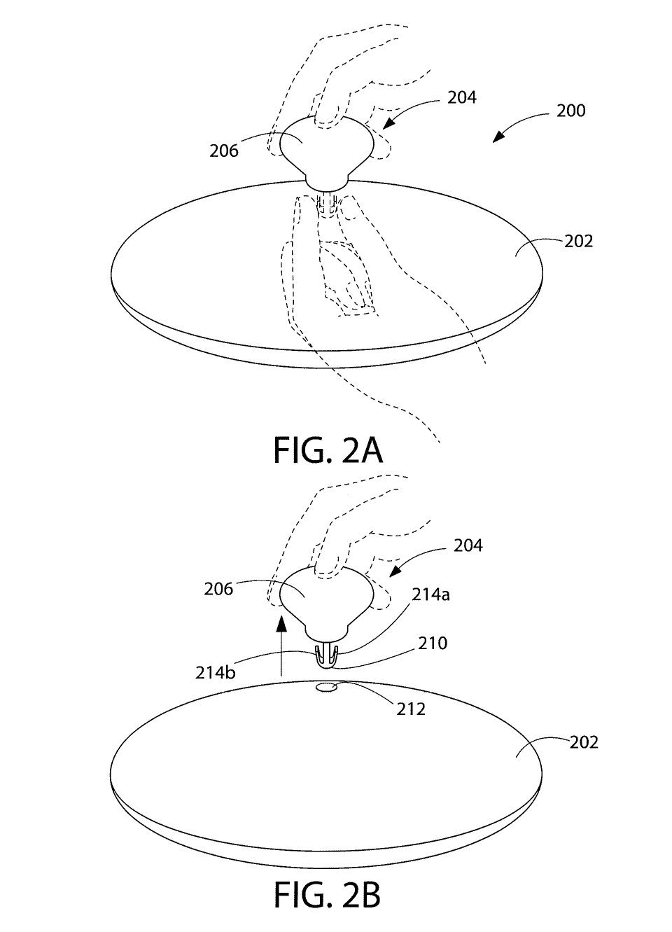

Referring now to FIGS. 2A and 2B, there are shown isometric views of a second exemplary embodiment of a lid and handle combination 200 of the present invention. The combination 200 includes a lid 202 and handle 204 removably secured thereto, as shown in FIG. 2A.

The handle 204 includes a knob 206 and a projection 210 extending downward therefrom. The projection 210 includes preferably two resilient members 214a,b located opposite one another. In their natural state, the resilient members 214a,b are biased outwardly, i.e., away from the central axis of the projection 210. The resilient members 214a,b are pliable and may be manually squeezed and compressed towards each other. When the resilient members 214a,b are released, they revert to their natural, outwardly biased state.

The projection 210 is insertable into a thru-hole 212, which is preferably centrally located on the top of the lid 202. When a user desires to attach the handle 204 to the lid 202, the user may simply insert the projection 210 into the thru-hole 212 until the handle can go no further towards the lid 202. As the projection 210 is inserted into the thru-hole 212, the resilient members 214a,b are squeezed inward, towards the central axis of the projection, thereby providing adequate clearance for the projection 210 to fit in the thru-hole 212. Once the resilient members 214a,b clear the inner surface of the thru-hole 212, i.e., below the underside of the lid 202, the resilient members 214a,b return to their natural, outwardly biased state. The user may then slightly pull the handle 204 upward, towards the underside of the lid 202. In so doing, the resilient members 214a,b engage a catch (not shown) on the underside of the lid 202. The catch facilitates, for example, a snap fit or slight interference fit between itself and the resilient members 214a,b and/or other portions of the projection 210. Preferably, the engagement between the catch and the resilient members 214a,b and/or other portions of the projection 210 is snug and strong enough such that slight or inadvertent downward pressure on the handle 204 will not disengage the resilient members 214a,b and/or other portions of the projection 210 from the catch.

When a user desires to separate the handle 204 from the lid 202, the user applies sufficient downward pressure on the handle 204 to disengage the resilient members 214a,b and/or other portions of the projection 210 from the catch. Next, the user manually squeezes the resilient members 214a,b towards each other until there is sufficient clearance for the projection 210 to be pulled through the thru-hole 212. The user may then simply pull the handle 204 away from the lid 202, thereby disassembling the lid and handle combination 200. In this way, the handle 204 may be removably secured to and detached from the lid 202, with minimal effort and without the use of tools.

If desired, the handle 204 may be an assembly comprising the projection 210 and knob 206, wherein the projection 210 is removably securable to the knob 206 without the use of tools. Similarly, if desired, the handle 104 of FIG. 1 may be an assembly comprising the shaft 110 and the knob 106, wherein the shaft 110 is removably securable to the knob 106 without the use of tools. The projection 210 or shaft 110 may be secured to their respective knobs 106,206 by any manner of removably securing two parts together, utilizing, for example, the various ways in which handles may be removably secured to lids, as described herein.

Accordingly, in one aspect, the present invention contemplates a three piece assembly comprising a lid, a knob or handle and an intermediate member having first and second ends, the intermediate member being releasably securable to the knob or handle at the first end and being releasably securable to the lid at the second end. An advantage to this type of arrangement is that the intermediate member (e.g., shaft 110 or projection 210), may be compatible with different size lids and handles. Thus, for example, a set having different size lids that use different size handles may utilize “one size fits all” universal intermediate members, which are interchangeable between the various lids and handles.

In another embodiment (not shown), a knob or handle comprises a suction cup, e.g., on the base thereof. The suction cup is preferably made of a material having a high melting point and ability to tolerate and function in very hot ambient temperatures and/or when secured to a very hot surface, e.g., when used for cooking. The suction cup, when pressed onto the top surface of a lid, creates low pressure between the suction cup and the lid. As such, the lid and knob/handle should not be separable by pulling on the handle with slight or inadvertent force, e.g., such force as would be exerted in normal use through simply lifting the lid. However, a person may be able to remove the knob/handle from the lid using sufficient deliberate pulling force. In this way, the knob/handle may be secured to and removed from the lid without the use of tools. If desired, the portion of the lid where the suction cup is secured to comprises a material having low thermal conductivity.

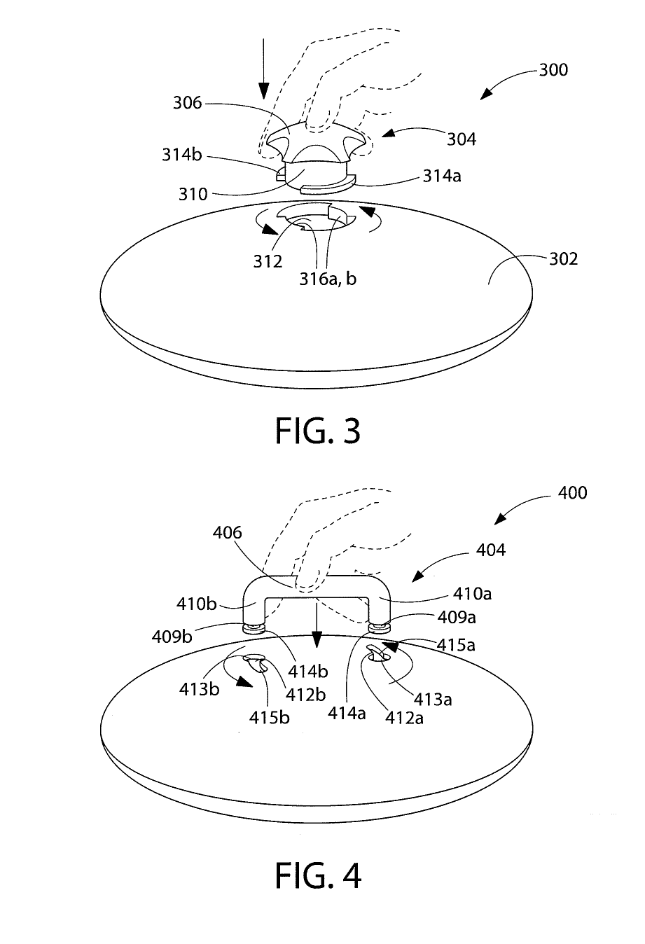

Referring now to FIG. 3, there is shown an isometric view of a third exemplary embodiment of a lid and handle combination 300 of the present invention, wherein the handle 304 is separated from the lid 302.

The handle 304 preferably comprises a knob 306 and a trunk 310 rigidly extending downward therefrom. The trunk 310 preferably includes two ridges 314a,b extending outwardly from the trunk 310, along a portion of the periphery thereof. The ridges 314a,b are preferably positioned directly opposite one another and of equal dimensions, such that the underside of the trunk 310 and ridges 314a,b appears substantially symmetrical.

The lid 302 includes a cavity 312, preferably centrally located on the top of the lid 302. The shape and dimensions of the periphery of the cavity 312 are preferably substantially identical to those of the underside of the trunk 310 and ridges 314a,b, such that the trunk 310, when properly aligned, is insertable into the cavity 312.

When a user desires to secure the handle 304 to the lid 302, the user aligns the trunk 310 and ridges 314a,b with the complementary geometry of the cavity 312 and inserts the trunk 310 into the cavity 312. Next, the user slightly rotates the handle 304 in a locking direction relative to the lid 302, e.g., 10°-180° (preferably about)90°, such that the ridges 314a,b are secured beneath two complementary protrusions 316a,b that are located along the periphery of the cavity 312. Preferably, when the ridges 314a,b are secured beneath the protrusions 316a,b, the ridges 314a,b snugly engage complementary geometry (not shown), e.g., in a slight interference fit or snap fit. This would prevent the handle 304 from being disengaged from the lid 302 when only slight or inadvertent torque is applied to the handle 304.

When the user desires to separate the handle 304 from the lid 302, the user manually applies sufficient torque to the handle 304 to rotate it in an unlocking direction relative to the lid 302, e.g., 10°-180° (preferably about)90°, i.e., in the opposite direction that it was rotated to secure the handle 304 to the lid 302. Once the ridges 314a,b clear the protrusions 316a,b, the user simply pulls the handle 304 away from the lid 302, thereby disassembling the lid and handle combination 300. Optionally, the trunk 310 and cavity 312 include oppositely charged magnets that attract one another and thus add an additional level of strength in the connection between the lid 302 and handle 304. In addition, magnetizing the trunk 310 would allow a user, for example, to conveniently store the handles 304 by sticking them on a refrigerator.

Referring now to FIG. 4, there is shown an isometric view of a fourth exemplary embodiment of a lid and handle combination 400 of the present invention, wherein the handle 404 is separated from the lid 402.

The handle 404, which is embodied as a pull handle, preferably includes a horizontal gripping portion 406 and two substantially vertical shafts 410a,b extending downward from the gripping portion 406. The bottom of each respective shaft 410a,b includes a cut-out 409a,b and a preferably circular ridge 414a,b around the periphery thereof.

The lid 402 includes preferably two cavities 412a,b that are spaced apart from each other on the top of the lid 402. Each respective cavity 412a,b comprises an open portion 413a,b and a narrow portion 415a,b. The cavities 412a,b are spaced from each other and dimensioned such that when properly aligned with the handle 404, each respective shaft 410a,b is insertable into a corresponding open portion 413a,b of a respective cavity 412a,b.

When a user desires to secure the handle 404 to the lid 402, the user aligns the shafts 410a,b with corresponding open portions 413a,b of respective cavities 412a,b and inserts the shafts 410a,b into the corresponding open portions 413a,b. Next, the user slightly rotates the handle 404 relative to the lid 402 in a locking direction, e.g., 5°-90° (preferably about)10°-30°, such that the ridges 414a,b are secured beneath respective narrow portions 415a,b of the cavities 412a,b. Preferably, when the ridges 414a,b are secured beneath the respective narrow portions 415a,b, the ridges 414a,b snugly engage complementary geometry (not shown), e.g., in a slight interference fit or snap fit. This would prevent the handle 404 from being disengaged from the lid 402 when only slight or inadvertent torque is applied to the handle 404.

When the user desires to separate the handle 404 from the lid 402, the user manually applies sufficient torque to the handle 404 to rotate it in an unlocking direction relative to the lid 402, e.g., 5°-90° (preferably about)10°-15°, i.e., in the opposite direction that it was rotated to secure the handle 404 to the lid 402. Once the ridges 414a,b clear the narrow portions 415a,b, the user simply pulls the handle 404 away from the lid 402, thereby disassembling the lid and handle combination 400. Optionally, the shafts 410a,b and cavities 412a,b respectively include oppositely charged magnets that attract one another and thus add an additional level of strength in the connection between the lid 402 and handle 404. In addition, magnetizing the shafts 410a,b would allow a user, for example, to conveniently store the handles 404 by sticking them on a refrigerator.

Both the embodiments shown in FIGS. 3 and 4 and as described herein enable a user to removably secure and detach handles to/from lids, with minimal effort and without the use of tools. Certainly, numerous additional variations of handle and lid combinations may incorporate the novel concept of enabling a user to secure and detach a handle to/from a lid with minimal effort and without the use of tools. For example, a handle may include a threaded shaft (not shown) that only requires a quarter or half turn (e.g., about 90° or about 180°) in a threaded cavity in a lid to secure/remove the handle to/from the lid. Another example may include a handle comprising a snap lock pin capable of snapping into a cavity in the top of a lid by simply pushing the handle into the cavity. The lid and handle should not be separable by pulling on the handle with slight or inadvertent force, e.g., such force as would be exerted in normal use through simply lifting the lid. However, the handle may be removed by simply pulling with sufficient force to disengage the snap lock between the handle and the lid.

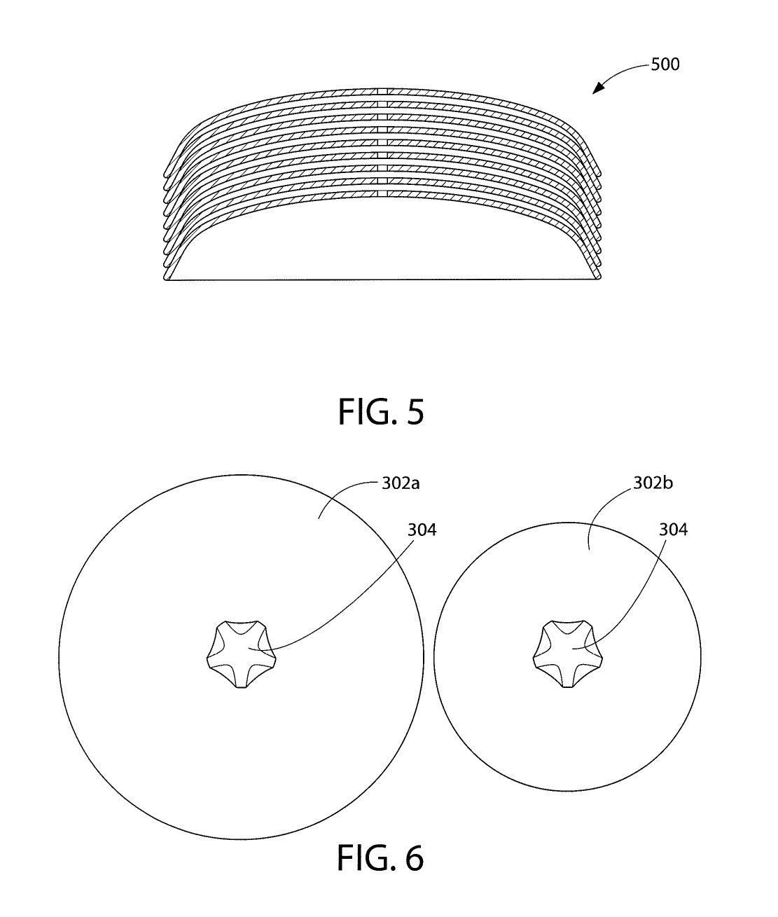

As discussed above, the advantage of enabling handles to be easily removed from lids of cookware, such as pots or pans, is to allow for more organized and space-conserving storage of the lids. For example, lids may be constructed so that their undersides neatly mate with the top sides of other lids in a set. Referring now to FIG. 5, there is shown a sectional view of a plurality of cookware lids 500 stacked one on top of the other. The lids as shown in FIG. 5 do not have their handles attached, thus allowing the lids to be stackable. Had the lids included their handles, the handles would have protruded from the top surface of each lid, preventing the lids from being stacked and snugly fitted, one on top of the other, as shown in the figure. Accordingly, as shown in FIG. 5, the invention enables a plurality of lids (i.e., two or more) to be neatly organized in a way that maximizes storage space.

In an alternative embodiment (not shown), cookware lids without handles may be organized very close to one another vertically or slightly slanted, e.g., using a rack. The absence of handles allows the lids to be situated very close to one another.

Referring now to FIG. 6, there are shown top views of two different sized lids according to the fourth exemplary embodiment of the lid and handle combination 300 of FIG. 3. Although the two lids 302a,b are sized differently, the handles 304 are preferably identical in size, shape and configuration to each other. In this way, the handles are preferably interchangeable with lids of various types and sizes. Having interchangeable lids adds yet an additional layer of convenience to a user.

The lids according to the present invention are primarily contemplated for use with cookware, but may have other uses as well. The lids according to the present invention may be, for example, made of materials such as metal, glass, stone, or a combination thereof. The handles according to the present invention may be, for example, made of materials such as metal, glass, stone, plastic or wood and may be thermally insulated for ease of handling. In addition, the present invention contemplates use of lids and handles of various types and shapes.

While the invention has been described in detail and with reference to specific examples thereof, it will be apparent to one skilled in the art that various changes and modifications can be made therein without departing from the spirit and scope thereof.

What is claimed is:

1. First and second cookware lids, the first cookware lid having a first handle removable therefrom and removably securable thereto without using a tool, the second cookware lid having a second handle removable therefrom and removably securable thereto without using a tool, the first cookware lid being stackable onto the second cookware lid when the second handle is not secured to the second cookware lid.

2. The first and second cookware lids of claim 1, wherein the second handle is removably securable to the second cookware lid by inserting a portion of the second handle into a cavity on a top side of the second cookware lid and rotating the second handle relative to the second cookware lid in a locking direction until the second handle is removably secured to the second cookware lid.

3. The first and second cookware lids of claim 2, the second handle being removably secured to the second cookware lid by rotating the second handle 5°-180° in a locking direction relative to the second cookware lid.

4. The first and second cookware lids of claim 3, the second handle being removably secured to the second cookware lid by rotating the second handle 45°-120° in a locking direction relative to the second cookware lid.

5. The first and second cookware lids of claim 1, wherein the second handle was removably secured to the second cookware lid by inserting a portion of the second handle into a cavity on a top side of the second cookware lid and rotating the second handle relative to the second cookware lid in a locking direction, the second handle being removable from the second cookware lid by rotating the second handle relative to the second cookware lid in an unlocking direction and then separating the portion of the second handle from the cavity.

6. The first and second cookware lids of claim 5, the second handle being removable from the second cookware lid by rotating the second handle relative to the second cookware lid 5°-180° in an unlocking direction relative to the second cookware lid and then separating the portion of the second handle from the cavity.

7. The first and second cookware lids of claim 6, the second handle being removable from the second cookware lid by rotating the second handle relative to the second cookware lid 45°-120° in an unlocking direction relative to the second cookware lid and then separating the portion of the second handle from the cavity.

8. The first and second cookware lids of claim 1, wherein the second handle is removably securable to the second cookware lid by inserting a portion of the second handle into a cavity on a top side of the second cookware lid until the portion of the second handle engages the cavity in a snap-fit.

9. The first and second cookware lids of claim 1, wherein the second handle is removably securable to the second cookware lid by inserting a portion of the second handle into a cavity on a top side of the second cookware lid until the portion of the second handle engages the cavity in a slight interference fit.

10. The first and second cookware lids of claim 1, wherein the second handle is removably secured to the second cookware lid by inserting a portion of the second handle into a cavity on a top side of the second cookware lid until the portion of the second handle engages the cavity in a snap-fit, the second handle being removable from the second cookware lid by applying sufficient manual pulling force to the handle until the snap-fit is disengaged and then separating the portion of the second handle from the cavity.

11. The first and second cookware lids of claim 1, wherein the second handle is removably secured to the second cookware lid by inserting a portion of the second handle into a cavity on a top side of the second cookware lid until the portion of the second handle engages the cavity in a slight interference fit, the second handle being removable from the second cookware lid by applying sufficient manual pulling force to the handle until the slight interference fit is disengaged and then separating the portion of the second handle from the cavity.

12. The first and second cookware lids of claim 1, wherein the second handle is removably securable to the second cookware lid by inserting a portion of the second handle into a cavity on a top side of the second cookware lid, the portion of the second handle being magnetically attracted to the cavity.

13. The first and second cookware lids of claim 1, wherein the first cookware lid is stacked onto the second cookware lid, the second handle not being secured to the second cookware lid.

14. A plurality of cookware lids, each lid having a handle removable therefrom and securable thereto without using a tool.

15. The plurality of cookware lids of claim 14, each handle comprising a knob and an intermediate member having first and second ends, the intermediate member being removably securable to the knob at the immediate member's first end without using a tool, the immediate member being removably securable to the lid at the intermediate member's second end without using a tool.

16. The plurality of cookware lids of claim 14, wherein the lids are stackable when the handles are not secured to the lids.

17. The plurality of cookware lids of claim 15, wherein the lids are stackable when the handles are not secured to the lids.

18. An assembly, comprising a lid, a knob and an intermediate member having first and second ends, the intermediate member being removably securable to the knob at the immediate member's first end without using a tool, the immediate member being removably securable to the lid at the intermediate member's second end without using a tool.
